(19) United States
(12) Patent Application Publication
(10) Pub. No.: US 2005/0174923 A1
(43) Pub. Date: Aug. 11, 2005

(54) Living audio and video systems and methods

(75) Inventor: Robert G. Bridges, Missoula, MT (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Contemporary Entertainment, Inc., Missoula, MT (US)

(21) Appl. No.: 10/777,381

(22) Filed: Feb. 11, 2004

(51) Int. Cl. G11B 7/24; G11B 13/00; G06F 12/00; H04N 5/781; H04N 5/91

(52) U.S. Cl. 369/275.3; 369/14; 711/111; 386/126; 386/95

(57) ABSTRACT

The present invention is directed to systems and methods for recording, storing and playing back audio and video works. In one embodiment, a method of presenting a variable work, such as an audio track, to a user includes presenting a first version of the work to the user. The first version has a trigger point therein. The method includes presenting a second version of the work to the user if the first version trigger point is reached during the presentation of the first version. If the first version trigger point is not reached, the first version is re-presented. In this manner, the use of a trigger point within the work can help determine whether the user should be presented with the same work again, or a different version of the work, upon subsequent views or listenings of the work.

### BACKGROUND OF THE INVENTION

The present invention is directed generally to systems and methods for recording and playing back audio and video. More specifically, the present invention provides systems and methods for creating audio and video tracks in a manner which provides far greater variance for audio listeners and video viewers.

### BRIEF SUMMARY OF THE INVENTION

The present invention is directed to systems and methods for recording, storing and playing back audio and video works. In one embodiment of the present invention, a method of presenting a variable work, such as an audio track, to a user includes presenting a first version of the work to the user. The first version has a first version trigger point therein. The method includes presenting a second version of the work to the user if the first version trigger point is reached during the presentation of the first version. If the trigger point is not reached, the method includes re-presenting the first version. In this manner, the use of a trigger point within the work can help determine whether the user should be presented with the same work again, or a different version of the work.

In one aspect, the first version of the work has a plurality of tags, with at least one of the tags comprising the first version trigger point. In a particular aspect, the first version trigger point is the last tag in the work. In other embodiments, the trigger point is positioned within the work as a function of a total length of the work, or is positioned within a desired location or segment of the work.

In one aspect, the first version of the work is re-presented after a delay period. This may occur, for example, if the user is presented the first version for a period of time insufficient to pass the first trigger point when the presentation is stopped. After some delay of minutes, hours, days or weeks, the first version is re-presented since the trigger point was not reached in the prior presentation of the work.

In one aspect, a third version of the work is presented to the user if during the presentation of the second version, a second version trigger point is reached. In a particular aspect, the first, second and third versions of the work are presented in a predetermined order. The presenting of the work comprises, in alternative embodiments, playing a disc having the first version disposed thereon, or accessing an electronic file having the first version disposed therein.

The present invention further provides storage medium having audio tracks embodied therein. In one embodiment, the storage medium includes an N number of audio tracks and V versions of at least one of the N audio tracks. The storage medium further includes a control track having information for determining which of the V versions is to be played. In one aspect, the control track contains information regarding the number of times a certain version shall be played back before proceeding to the next version. In one aspect, the control track information may be layered within the different song versions, instead of as a separate track.

In one aspect, each V version is stored in its entirety on the storage medium, and represents a complete version of one of the N audio tracks. In a particular aspect, N is at least two (2) and V is at least four (4). In some aspects, the storage medium is an optical storage medium, although other storage media also fall within the scope of the present invention. In still another embodiment, each of the V versions has a trigger point, or multiple trigger points.

The present invention further provides audio players and systems adapted to play audio tracks embodied in a storage medium. In one embodiment, the audio player includes a detector adapted for detecting a trigger point in at least one of the audio tracks. The trigger point is used for determining which version of the audio track is to be played. The player includes a decoder for decoding a correct version of the audio track and forwarding the audio track to an amplifier. In this manner, the correct version of the audio track is played to a listener.

In one aspect, the detector is further adapted for reading a control track embodied on the storage medium. The control track includes information for determining which audio track is to be played. In another aspect, the decoder is adapted for decoding a first version of an audio track the first time the audio track is played, and decoding a second version of the audio track the Nth time the audio track is played. N may be most any number, and in one embodiment is included in the control track. In still another aspect, the decoder includes a software-based decoder adapted to be loaded into an audio player memory. In this manner, the decoder may be downloadable or uploadable software. In one aspect, the decoder is adapted to decompress the correct audio track. In this manner, audio tracks may be stored in compressed format and decompressed for playback.

In one embodiment of the present invention, a method of recording a song is provided. The method includes recording a song base version, and mixing three versions of the song base version. The base song and three versions are encoded on a storage medium. A control track also is encoded on the storage medium. The control track includes information for determining which of the base version, first version, second version or third version is to be played.

In a particular aspect, the first through third versions are recognizable variations of the song base version. In one aspect, the first version is more similar to the base version than is the second version. The similarities may be based on overall song structure similarities, and/or similarities in the number of instruments and vocal components in the various song versions. The song versions also may be quite varied or dissimilar based on desires of the artist, and may vary in number from song to song.

The summary provides only a general outline of some embodiments according to the present invention. Many other objects, features and advantages of the present invention will become more fully apparent from the following detailed description, the appended claims and the accompanying drawings.

### BRIEF DESCRIPTION OF THE DRAWINGS

FIG. 1 is a flow chart of a method for recording audio tracks according to an embodiment of the present invention;

FIG. 2 is a schematic depiction of a medium containing recorded tracks according to the present invention;

FIGS. 3A-3C are schematic time lines of different versions of an audio track according to the present invention; and

FIGS. 4A and 4B depict simplified schematics of audio and/or video playback devices according to embodiments of the present invention.

### DETAILED DESCRIPTION OF THE INVENTION

As is known to those skilled in the recording industry, a number of tracks or songs typically are compiled together to sell to the consuming public. In the 1980s and earlier, the songs would be imprinted on vinyl discs or albums, to be played by record players, jukeboxes or the like. More typically today, the compilation of songs are deposited onto a compact disc (CD). A typical CD, for example, will have a series of songs or tracks on the disc, with each song recorded on the disc only a single time. The users listening to the CD have, for example, a single rendition of song A, a single rendition of song B, and the like. Each playback of song A sounds like any other playback of song A. Systems and methods of the present invention provide much greater variance to the listener.

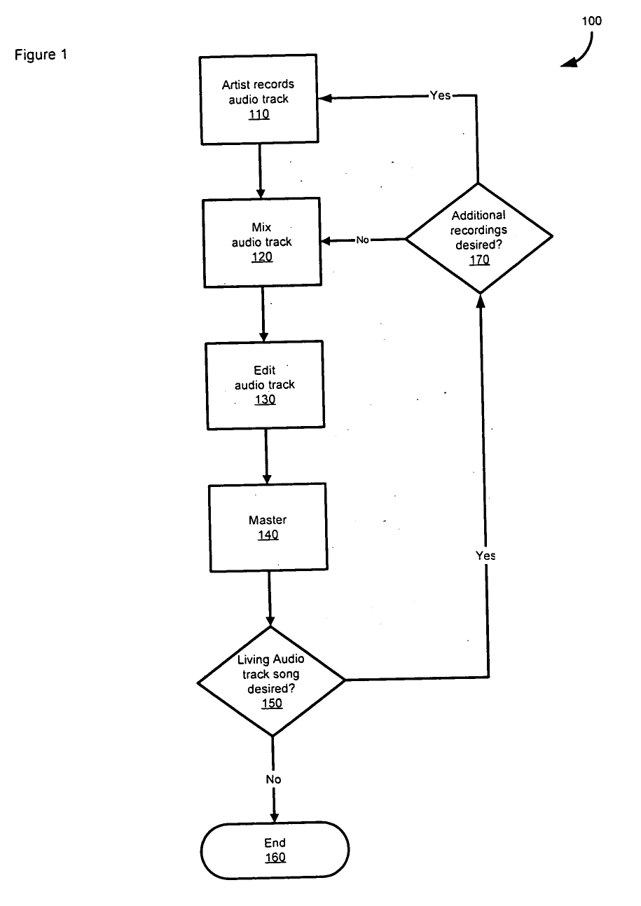

With reference to FIG. 1, an exemplary method 100 of the present invention will be described. Method 100 is directed to the recording, mixing, editing and mastering of audio tracks for subsequent playback. The below description generally discusses the recording of songs, however, the invention extends beyond music recording. For example, audio tracks recorded in accordance with the present invention may include not only songs of any genre, but also speeches, audio books, comedy albums, motivational tapes, and the like.

In one particular embodiment for the sake of illustration, method 100 involves a musician, musical group or recording artist recording a group of songs for a new album to be sold to the public. In method 100, the recording artist performs and records an individual audio track or song (Block 110). This may occur, for example, in a multi-channel recording studio as is known to those skilled in the art. In one embodiment, each instrument or vocal component (lead, backup, harmony, etc.) is recorded on an individual or separate channel. After recording, the audio track is then mixed (Block 120). Mixing is used to form a multi-layer representation of the performance, combining the various instruments, vocals, sound effects, and the like. Mixing typically produces a stereo (two track) master of the song. In another embodiment, the song is mixed to multichannel for additional playback effects including, for example, a surround sound effect.

Once mixed, the audio track is edited (Block 130), as deemed appropriate by the recording artist and/or recording studio. Editing may involve, for example, changes to the song structure, placement of a verse or chorus, deletion of portions of the song, and the like. The artist obviously has input in the recording process (110), and also may have input in the mixing (120) and editing (130) processes. The audio track is mastered (Block 140) to be prepared for creating a consumer product. For example, audio tracks may be mastered for creating a CD, a digital variable disk (DVD), a digital video or audio disc, a super audio disc, other recording media and the like.

During the recording process, the artist determines whether a particular song will be mixed once, or a multiple of times (Block 150). Songs that are to be mixed more than once are referred to herein as “living audio” or a “living audio track or song.” If a living audio track is not desired, the recording process ends for that song (Block 160).

If a living audio track is desired (Block 150), the artist or recording studio will determine if additional recordings are desired (Block 170). If additional recordings are desired, in one embodiment the artist will record the song again (Block 110). In other embodiments, additional musical tracks are recorded, with the performer playing or singing along with a playback of the original recording or a portion thereof. In some embodiments, different recordings include guest performers, non-vocal versions, or different performance takes, such as an added guitar solo. Other recordings substitute similar instruments, such as an acoustic guitar for an electric one, add or drop vocal components, are performed in a different key, and the like. In one embodiment, the additional musical tracks (e.g., guitars, vocals and the like) are recorded in the initial recording session to create more components available for mixing the living audio tracks. Alternatively, the additional recordings or tracks may be obtaining during a subsequent recording session. When mixing the various versions of the living audio selection, these components would be used to create variances between mix versions.

Each re-recording of the song or additional tracks may have one or more changes from the original recording of the song. In addition to intentional changes to the song, unintentional changes also may be recorded. Each new version of the audio track is then mixed (Block 120), edited (Block 130), and subsequently mastered (Block 140). By recording the song or its components more than once, more creative and varied mixes can be produced.

In another embodiment, additional recordings or tracks are not needed or desired. (Block 170). In this embodiment, the various song versions are produced through the mixing process 120 using previously recorded song tracks and components. The re-mixed living audio track(s) will have some variance from the original recording. In general, the instrumentation and/or structure of the song may change to allow more versatility during the mixing process. As further described below in conjunction with subsequent figures, the re-mixed song may have verses added or deleted, longer or shorter introduction sections, instruments added, changed or dropped, background vocals highlighted or diminished, and a wide variety of other changes.

In one embodiment, the artist continues to re-record and/or re-mix a particular song until a desired number of versions of the song have been created. In one embodiment, the total number of versions of a song range between about two (2) versions and about twelve (12) versions. In another embodiment, between about four (4) and about eight (8) versions of the desired song are created. Each recording of the song may produce one version or more than one version of the song, by the mixing and editing of the recorded material. In one embodiment, the number of mixes available to each living audio track may vary, and is otherwise not limited to a particular number.

During the mixing process, the artist may choose to have the various versions or mixes of the living audio song vary from a “full band” mix with vast instrumentation to a simple mix of one instrument and vocal. In one embodiment, the performer includes different styles and/or instruments from mix to mix. After some number of versions of an audio track have been recorded, mixed and edited, the artist, recording studio or the like will decide to stop creating new versions (Block 150). The recording and mixing processes are terminated (Block 160).

The mastering process for each version of the song will be the same or nearly the same as the mastering for the original version of the song. After the mastering process, however, a greater number of songs or living audio versions of a particular song may exist. One advantage of the present invention involves the multiple stages at which the recording artist has input into not only the original version of a song or performance, but also living audio versions or mixes of that song. In one embodiment, the mastered stereo mixes are full length songs. In another embodiment, varied full length song versions are sequenced in a desired order selected by the recording artist.

In one embodiment, the master selections will be finalized in an audio compression format not recognized by standard digital to analog converters. This allows for the storage of more information, such as multiple versions of songs, and the encoding of a control track that relays playback information to a playback unit. In one embodiment, each living audio song will have its mixes sequenced in a desired order, and may label each mix with a sequential alphabetical or numerical character.

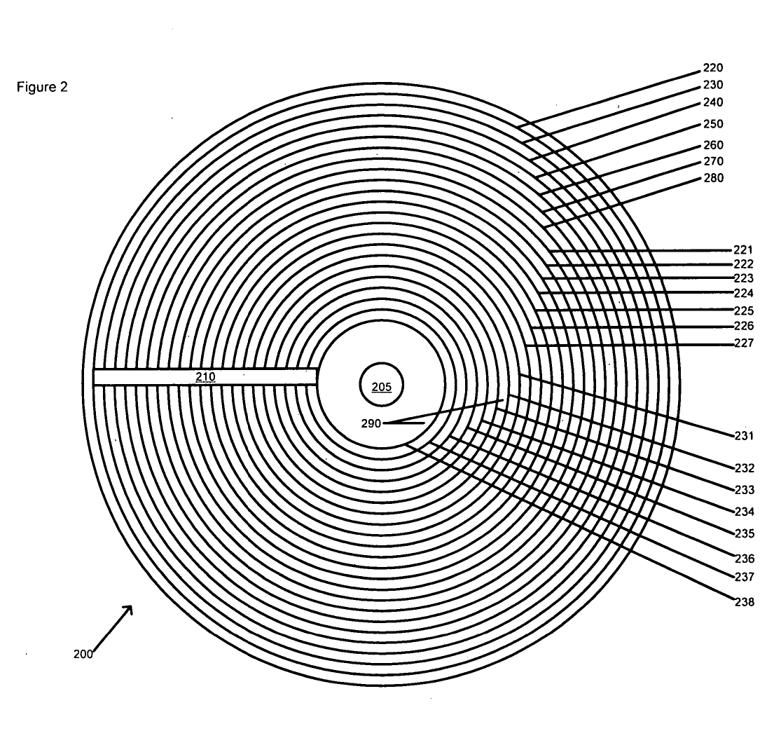

FIG. 2 shows a schematic version of a CD, DVD, or other recording media 200 (collectively CD 200 herein). CD 200 has a first recording surface 210 and a central opening 205. Opening 205 is adapted to engage various CD playing devices that rotate CD 200 at a speed to facilitate the playback of songs recorded on CD 200. In one embodiment, CD 200 has a plurality of songs recorded on surface 210. For example, in one embodiment, seven songs 220, 230, 240, 250, 260, 270 and 280 are recorded on CD 210. This portion of CD 200 may appear similar to standard CDs known to those skilled in the art. However, CD 200 further contains living audio versions of one or more songs 220-280. For example, song 220 was recorded, mixed, edited and mastered to produce seven subsequent versions thereof in addition to the original version of song 220. The seven additional versions of song 220 are shown depicted as arcs 221-227. Further, eight additional versions of song 230 are shown recorded on CD 200 by arcs 231-238. While FIG. 2 depicts original songs 220-280 and seven or eight additional versions of songs 220 and 230 recorded on CD 200, the invention is obviously not limited to a particular number of songs or song versions. A smaller or larger number of versions of each song, of some songs, or of all the songs may be recorded on CD 200 within the scope of the present invention. Songs also are shown represented by arcs, but the songs may be stored on CD 200 as part of a continuous spiral track, and in other physical arrangements. Other storage media such as DVD, hard disk, tape, and others may be used to store the original song versions or living audio versions. Storage of audio or video may be contained on additional disks, hard disk, tape, and the like. The audio or video may be in compressed or non-compressed format.

CD 200 further includes a control track 290 embedded on surface 210. Control track 290 may be positioned in a variety of locations, including between the living audio song tracks, or at the end of the portion of CD surface 210 containing the songs or other audio tracks. Control track 290 includes information to govern the living audio playback process. In one embodiment, the recording artist's desired presentation procedure and/or order for song 221 and song versions 222-227 are embodied in control track 290. Control track 290 further may contain information used to determined whether a song 221, and 222-227 has been “listened to” as further described below. For example, the recording artist may want the listener to hear the original version of song 221 a certain number of times before the living audio versions 222-227 are presented. In this case, the listener will hear song 221 the desired number of times, say between about one (1) and about ten (10) times, when the CD track associated with song 221 is selected. This may occur over one or more listening sessions. After the listener has heard song 221 the desired number of times, control track 290 then directs the CD player to play the desired sequence of song versions 222-227. This may involve, for example, playing each song version 222-227 one time before playing the next song version. In one embodiment, each song version is played a desired number of times before the next version of the song is played. Control track 290 has embodied therein information which assists the CD player play the correct living audio song at any particular listening session.

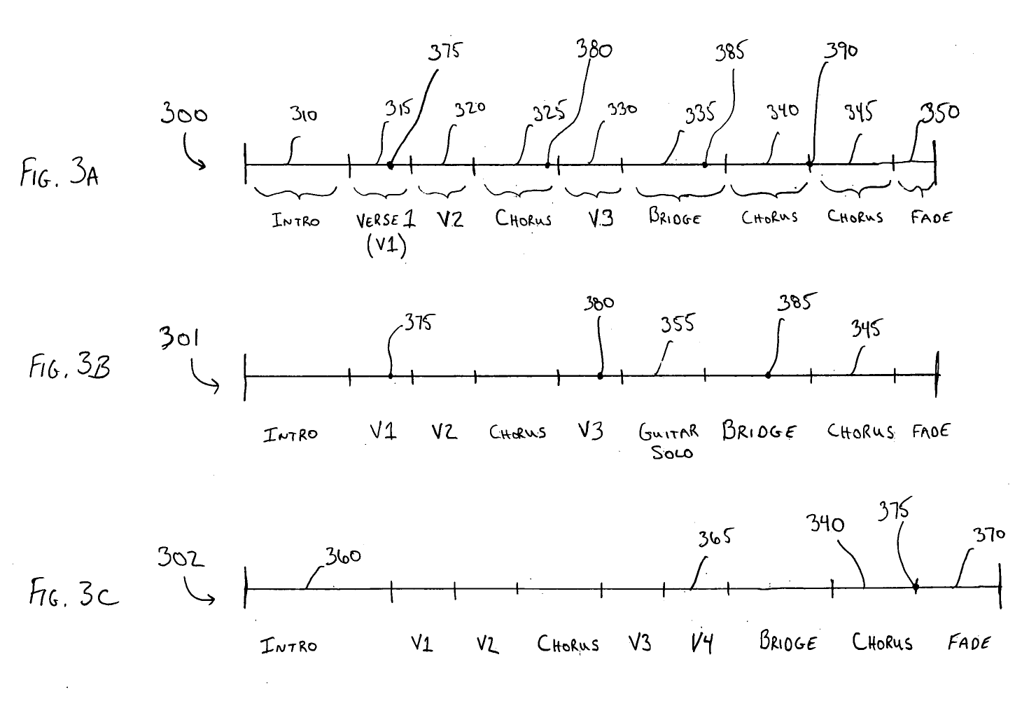

The stereo mixed version of each song 221-227, for example, are full length versions having slight variations from original song 220. In a particular embodiment, song 220 and 221 are the same, with songs 222-227 being versions thereof. This may be best illustrated with reference to FIGS. 3A-3C depicting the time line of three versions of a song 300. FIG. 3A depicts song 300 having an introduction section 310, a first verse 315, a second verse 320, and a chorus 325. Chorus 325 is followed by a third verse 330, a bridge section 335, and two chorus sections 340 and 345. Song 300 ends with a fade portion 350. In one embodiment, song 300 depicted in FIG. 3A represents the original version of song 220. In other embodiments, song 300 represents any of the seven variations indicated by arcs 221-227 shown in FIG. 2.

FIG. 3B depicts a song 301, which is a different living audio version of song 300. As can be seen in FIG. 3B, a guitar solo 355 has been added and chorus section 340 has been deleted. FIG. 3C depicts a song 302, which is still another version of song 300. In this version, the introduction 360 has been lengthened, the fade portion 370 has been lengthened, a fourth verse 365 has been added and chorus 345 has been deleted. In one embodiment, song 300 is an original song, and songs 301 and 302 are two living audio versions of song 300. While song 300 is approximately the same length as the version embodied in song 301, the changes resulting in song 302 produced a slightly longer song. It will be appreciated by those skilled in the art that the various versions of a song or living audio track may all be the same length or may have different lengths, both shorter or longer than the original song. This is possible, in part, because in one embodiment the different mixes of the song do not need to interact with each other. Further, while songs 300-302 have been described with an emphasis on varying song structure, other differences also may exist including those noted elsewhere herein.

As shown in FIG. 3A, song 300 has one or more tags associated therewith. Tags may comprise a bit marker or other indicator embedded within song 300. For example, FIG. 3A shows a first tag 375 within first verse 315, a second tag 380 within chorus 325, a third tag 385 within bridge section 335, and a fourth tag 390 at the end of chorus 340. Similarly, song 301 has tags associated therewith. As shown in FIG. 3B, tags 375-390 may not necessarily be in the same location of song 301 as they were in song 300, and each version of song 300 may not have the same number of tags. For example, first tag 375 and third tag 385 are in the same location of first verse 315 and bridge section 335, respectively. However, second tag 380 has been moved to third verse 330, and fourth tag 390 has been deleted. Finally, song 302 shown in FIG. 3C has just a single tag, first tag 375, located near the end of the song. In one embodiment, tags 375-390 are read by a living audio decoder contained within a CD, DVD, MP3, or other audio component as further described below. In another embodiment, a single tag contains the information needed to play the chosen living audio version a predetermined number of times before moving to the next version of the same song. The number of plays needed to advance from one version to the next version may vary from mix to mix, from song to song, and the like.

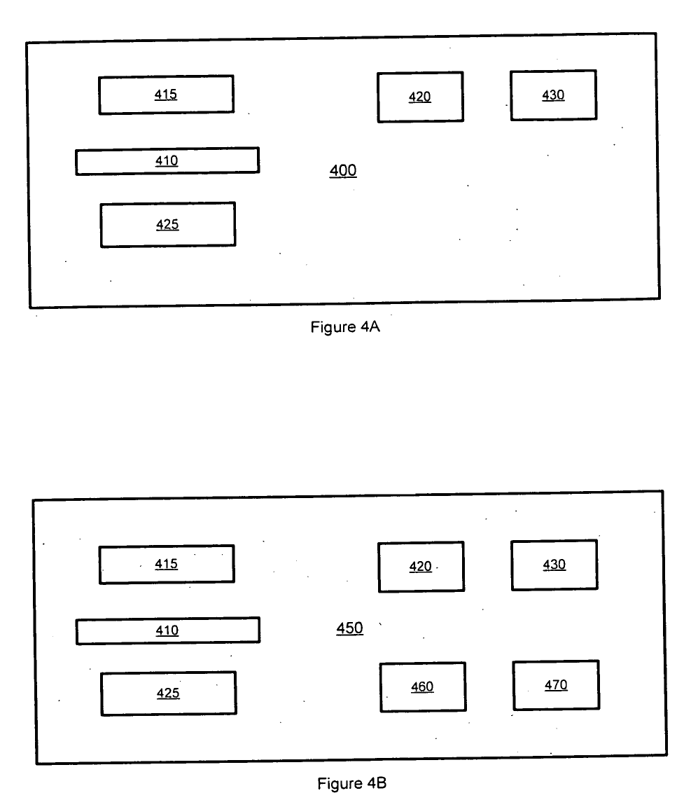

FIG. 4A depicts a simplified schematic of a CD, DVD, or other audio/video component player/recorder 400 (hereafter player 400). Player 400 includes an input/output device 410 adapted for receiving CD 200 or the like. Once disposed within player 400, CD 200 is rotated at the appropriate revolutions-per-minute (rpm) by a drive motor. The data stored in layers on recording surface 210 of CD 200 is read using a laser and lens system 415. The laser is guided relative to recording surface 210 using a tracking mechanism 425. In one embodiment, data read from CD surface 210 passes through a digital-to-analog converter 420 and an amplifier 430, to produce a song for the listener. Player 400 may include other components as known to those skilled in the art. Player 400 is adapted for playing standard CD/DVD discs or other audio/video media containing, for example, music stored thereon in standard audio format. In this embodiment, player 400 is capable of playing only standard audio formats, and living audio tracks on CD 200 are not read or played. For example, player 400 is capable of playing songs 220 and 230, but does not play song versions 221-227 and 231-238.

FIG. 4B depicts a player/recorder 450 having living audio playback technology according to the present invention incorporated therein. Player/recorder 450 has a similar input/output device 410, laser and lens system 415, tracking mechanism 425, digital-to-audio converter 420, amplifier 430, and the like, as does player 400. Player/recorder 450 further includes a living audio decoder 460 and a control track monitoring sensor or detector 470. Living audio decoder 460 is adapted for converting digital information on CD 200 for amplification by amplifier 430 for playback. Decoder 460 decodes the stored living audio tracks, which in some embodiments are stored in MP3, DVD or other audio format, for example. In this manner, larger program storage is available on CD 200. In one embodiment, decoder 460 is further adapted for reading tags, markers or the like disposed within living audio versions of songs. For example, living audio decoder 460 may be adapted for reading tags 375, 380, 385 and 390 schematically depicted in FIGS. 3A-3C.

Control track monitoring sensor 470 is adapted to retrieve information from control track 290, to execute the living audio playback process. For example, sensor 470 reads information from control track 290 which governs the order and rules associated with switching from song 221, to the various song versions 222-227. In this manner, decoder 460 is instructed to reproduce the correct song version during playback. Tag information is read, incremented and stored in the memory of player 400 for tracking the number of plays of each song version.

By way of example, in one embodiment the recording artist determines that original song 300 is to be played back the first time the user listens to a disc, with versions 301 and 302 following in order after song 300 has been listened to the first time. This may occur, for example, on three separate plays of CD track “X” corresponding to song 300. In other words, the first time track X is requested by the listener, song 300 is played. The second time track X is requested by the listener, song 301 is played and song 300 is not. The third time track X is requested, song 302 is played and songs 300 and 301 are not. In this manner, the song played to the listener transitions over time from song 300 to song 302, with accompanying variances in the song structure, time, format, etc. Further, in one embodiment the variance between song versions is dictated by the recording artist to provide a desired effect to the listener.

One benefit of tags 375-390 embedded within living audio versions of songs is their ability to be read by decoder 460. The reading of tags 375-390 within the song versions is used, in one embodiment, to allow the subsequent transition to a different version of a song. This may be accomplished in a number of different ways within the scope of the present invention. For example, in one embodiment all tags disposed within a song must be bypassed or read prior to the decoder 460 acknowledging that that version of the song version has been played. Once the song has been “played” the desired number of times, a different version is presented to the listener the next time the song is requested. In situations where the song is not listened to in its entirety, the last tag within the song may not be read by decoder 460. In this case, decoder 460 will not register that the song has been played in its entirety. The next time the song is requested by the listener, the same version of the song is played again.

Using the last tag within a song is one of a number of ways within the scope of the present invention to indicate when different song versions should be presented to the listener. For example, in one embodiment, a particular tag is the trigger point to permit playback of a different version of the song the next time the song is requested. In this embodiment, the trigger point tag must be bypassed or read prior to that song being registered as having been listened to by the user. In another embodiment, a majority of the tags need to be bypassed or read prior to that song being deemed listened to. If the user pulls the disc out of the player 450, or stops the play of a particular song or track before a majority of the tags have been hit, the player does not recognize that that version of the song has been played. As a result, the same version of the song will be replayed next time the user attempts to listen to that song.

In a particular embodiment of the present invention, each CD 200, and/or each CD “track”, and/or each song on CD 200 has a code associated therewith. The code is saved to a memory in player 450. The player has the ability to “remember” which song version was last played for the listener. In this manner, the user will hear the recording artists' designated living audio version the next time CD 200 is inserted into player 450. In a particular embodiment, each CD 200 produced by the recording artist has a common code. For example, every CD entitled “Fallen” by the group “Evanescence” would have a common code or CD identifier encoded in the control track 290. As a result, the listener could insert another CD of “Fallen” into player 450, and player 450 would recall which song version of living audio track X the user last listened to. This feature will be useful, for example, in the event the user loses the original CD, borrows a CD, and the like.

In another embodiment, the user may actively select which particular version of the song to hear. This may occur, for example, by using a fast-forward feature within player 450 that forwards not only between different songs or “tracks” on CD 200, but also between different versions of a particular song. For example, with reference to FIG. 2, if a user has come to appreciate version 235 of song 230, the user may optionally select to listen to version 235. In one embodiment the user must select the desired living audio version each time they listen to CD 200. In another embodiment, decoder 460 is programmed so that all plays of the track corresponding to song 230 will instead play version 235.

In one embodiment of the present invention, living audio technology may be incorporated for use with existing songs. For example, many songs in existence today have a master version stored by the artist, recording studio or the like. Further, many songs also have an original audio track maintained in a computer file, on disc, tapes, in recording programs or the like. The original version may include the various audio tracks laid down by the artist when the song was recorded. One embodiment of the present invention involves creating versions of the song by re-mixing the song to delete, embellish, lengthen, shorten, or the like, various audio tracks.

This process is noted with reference to FIG. 1. In one embodiment, an existing song is re-mixed and re-edited to produce a living audio track version of that song as depicted by the “yes” loop from decision Block 150. This loop may be repeated as many times as necessary to created additional living audio versions. In some circumstances, the living audio versions of the existing song may not be as varied as would otherwise be possible for an original song. This may occur, for example, for songs that were recorded by a now-deceased artist. In this case, the artist cannot go back into the recording studio and record different nuances of the song. Changes to the song can still occur as described herein by re-mixing existing tracks. Moreover, additional tracks, such as additional instrumentals, vocals, and the like, can be recorded in the studio as depicted by the “yes” branch from decision Block 170. In one embodiment, these additional tracks are recorded (Block 110), then re-mixed (Block 120) and re-edited (Block 130) to produce additional living audio versions of the song. In this manner, in one embodiment living audio technology is extendable to existing songs or other recordings.

In still another embodiment, the functions of decoder 460 and/or control sensor 470 are incorporated into embedded software. In this embodiment, the software for performing decoder 460 and/or sensor 470 functions is a software plug-in. The software plug-in may be downloaded, such as from a web site, in one embodiment, or may reside on disc for uploading to player 400. In this manner, living audio functionality is incorporated into a “standard” CD/DVD player, an MP3 player, an IPOD, a computer audio or video program such as Media Player®, RealPlayer®, and the like.

Systems and methods of the present invention have further applicability to the movie and video industry. Typically, the film production company or director of a movie will script scenes to be produced, and then film the scripted scenes. The scenes are edited, printed and sequenced to produce a theatrical version of a movie, video or the like. In one embodiment, the theatrical version of the film is printed in standard DVD format, such as on a digital variable disc, digital video disc or the like. Playback of the DVD may occur on standard DVD playback equipment.

In one embodiment of the present invention, the director or production company produces additional scenes for the film. These scenes may include supplementary scenes to be inserted into the movie, alternative scenes to replace existing scenes in the move including alternative endings, additional prologue or forward material, and the like. The additional scenes are similarly edited and printed. The theatrical version of the film may be broken up into scenes or chapters on the DVD, to permit the movie viewer to view only a portion of the movie, start the movie at various points, and the like. In one embodiment, the theatrical version of the movie resides on a single DVD. In one embodiment, living audio versions of various scenes also will be printed on a DVD. This may occur on the same DVD as the theatrical version of the film, or on a second DVD. The director and/or production company will have input as to the playback sequence of the various scenes. For example, tags or buttons are inserted into various movie scenes to indicate the desired trigger point for modifying the movie during playback. In one embodiment, the modifications involve inserting additional scenes, deleting scenes, and replacing scenes with one or more alternative scenes or endings.

The living video version of the movie is mastered and printed on a DVD or other storage media to include the additional scenes or alternative endings. Data is encoded on a control track that will guide the living video playback unit to play the desired chapter selection. Additional scenes or alternative endings are given a “chapter” status. The control track, as determined by the film producer or director, will link the chapters together forming the motion picture playback. As predetermined by the director, some chapters are left out and others may be substituted. The chapters have buttons encoded in the program that monitors the frequency of playback of those chapters. After a predesigned number of playbacks, the control track will alter the chapters that are being removed and the chapters that are being substituted or added, all per the artist's or director's discretion. Alternative endings are formed as chapters are substituted in the same manner as chapters previously in the movie. In one embodiment, at the end of the living video playback the end user is given the option of storing the version just viewed for future playback. Stored versions may be deleted or saved in onboard memory installed in the playback unit, in a separate storage device, or the like. In one embodiment, the end user may have the ability to sequence the chapters in a different order to create their own version of the film playback experience.

In this manner, a changing and varied film experience is provided to movie goers or movie watchers. The varied chapter selection is executed in a manner directed or specified by the director, producer, production company or the like. For example, the control track is programmed with chapter substitution, deletion, and addition patterns. The director, therefore, creates X number of versions of a film for view by the public. In one embodiment, films are released in living video format to be broadcast on various television or cable network channels.

In one embodiment, living video technology of the present invention is used to create new versions of old films. For example, many films are recorded to be much longer than the theatrical release of the movie, with the additional length attributed to varying scenes, endings, and the like, that were edited from the final version of the film. Typically, these additional scenes are maintained in a video library. In one embodiment of the present invention, a re-chaptering of a movie occurs by retrieving the previously recorded scenes and recording them on the same DVD as the original version of the movie. Using a control track as noted above, new versions of existing films are created. In one embodiment, the new versions of existing films are re-released to the public for viewing in various movie theatres, sold on DVDs, played on television or cable network channels, and the like.

One use of the present invention for living video involves the sale of DVDs to the public for home viewing of a movie. In one embodiment, if the user has only a standard DVD playback device, the theatrical version of the movie will be played. This may occur notwithstanding the fact additional chapters and a control track have been stored on the DVD that is capable of providing alternative endings, substitute chapters, additional material, and the like. In one embodiment, the living video-equipped DVD playback device is capable of reading the control track and substituting various chapters within the movie version. In this manner, a different flow of the movie may be achieved.

For example, the disc may be placed in a DVD player equipped with living video playback technology. By tracking and maintaining information retrieved from various buttons or tags located within the chapters, and on the control track, the playback unit can change the various sequence of chapters, omit chapters and substitute others in a manner previously chosen by the director or producer. The playback content will vary from viewing to viewing of the film based on the predetermined sequence encoded by the director. In one embodiment, the disc will only produce the desired flow of chapters as encoded on the control track.

Whether a particular version of the movie is deemed viewed will depend in part on whether various tags or buttons are read by the playback process, in a similar fashion to that discussed above in conjunction with the playback of CD 200. Further, the various additional chapters and alternative endings are stored in chapter format on the DVD, and this allows the user to jump right to the alternative endings if they want to see the different ways the movie could end without viewing the movie again in its entirety. While this may be similar to reading the last page of a book first, such a feature does allow a user to envision alternative endings to a movie, and then decide whether they want to view the movie in its entirety leading up to that alternative ending.

Notwithstanding the above description, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

1. A method of presenting a variable work to a user, the method comprising:
presenting a first version of a work to the user, the first version having a first version trigger point therein;
presenting a second version of the work to the user if during the presenting of the first version the first version trigger point is reached; and
re-presenting the first version of the work to the user if during the presenting of the first version the first version trigger point is not reached.

2. The method as in claim 1 wherein the first version has a plurality of tags, and at least one of the tags comprises the first version trigger point.

3. The method as in claim 2 wherein the first trigger point is the last tag in the work.

4. The method as in claim 1 wherein re-presenting the first version of the work occurs after a delay period.

5. The method as in claim 1 wherein the work comprises an audio track.

6. The method as in claim 1 further comprising presenting a third version of the work to the user if during the presenting of the second version, a second version trigger point is reached.

7. The method as in claim 6 wherein the presenting of the first version, second version and third version of the work occurs in a predetermined order.

8. The method as in claim 1 wherein the first trigger point is positioned within the work as a function of a total length of the work.

9. The method as in claim 1 wherein the work comprises a plurality of segments, and wherein the first trigger point is positioned within a desired one of the plurality of segments.

10. The method as in claim 1 wherein presenting the first version comprises playing a disc having the first version disposed thereon.

11. The method as in claim 1 wherein presenting the first version comprises accessing an electronic file having the first version disposed therein.

12. A storage medium having audio tracks embodied therein, the storage medium comprising:
N number of audio tracks;
V versions of at least one of the N audio tracks; and
a control track comprising information for determining which of the V versions is to be played.

13. The storage medium as in claim 12 wherein N is at least two (2) and V is at least four (4).

14. The storage medium as in claim 12 wherein the N audio tracks and V versions are maintained on an optical storage medium.

15. The storage medium as in claim 12 wherein each of the V versions comprises a trigger point.

16. An audio player adapted to play audio tracks embodied in a storage medium, the audio player comprising:
a detector adapted for detecting a trigger point in at least one of the audio tracks, the trigger point used for determining which version of the at least one audio track is to be played; and
a decoder for decoding a correct version of the at least one audio track and forwarding the audio track to an amplifier.

17. The audio player as in claim 16 wherein the player is adapted to play an optical storage medium having the audio tracks embodied therein.

18. The audio player as in claim 16 wherein the detector is further adapted for reading a control track embodied on the storage medium, the control track comprising information for determining which audio track is to be played.

19. The audio player as in claim 16 wherein the decoder is adapted for decoding a first version of an audio track the first time the audio track is played, and decoding a second version of the audio track the Nth time the audio track is played.

20. The audio player as in claim 16 wherein the decoder comprises a software-based decoder adapted to be loaded into an audio player memory.

21. The audio player as in claim 16 wherein the decoder is further adapted to decompress the correct version of the at least one audio track.

22. A method of recording a song, the method comprising:
recording a song base version;
mixing a first version of the song base version;
mixing a second version of the song base version;
mixing a third version of the song base version;
encoding the base, first, second and third versions on a storage medium; and
encoding a control track on the storage medium, the control track comprising information for determining which of the base version, first version, second version or third version is to be played.

23. The method as in claim 22 wherein the first through third versions are recognizable variations of the song base version.

24. The method as in claim 22 wherein the first version is more similar in song structure to the base version than the second version is similar to the base version.

25. The method as in claim 22 wherein the first version is more similar in the number of instruments and vocal components to the base version than the second version is similar to the base version.
